(19) United States
(12) Patent Application Publication
(10) Pub. No.: US 2024/0040583 A1
(43) Pub. Date: Feb. 1, 2024

(54) COMMON TX BEAM INDICATION AND APPLICATION FOR UL

(71) Applicant: Lenovo (Beijing) Limited, Beijing (CN)

(72) Inventors: Bingchao Liu, Beijing (CN); Hongmei Liu, Beijing (CN); Lianhai Wu, Beijing (CN); Haiming Wang, Beijing (CN)

(73) Assignee: Lenovo (Beijing) Limited, Beijing (CN)

(21) Appl. No.: 18/258,368

(22) PCT Filed: Dec. 29, 2020
(86) PCT No.: PCT/CN2020/140478

§ 371 Date: Jun. 20, 2023

(51) Int. Cl. H04W 72/232; H04W 76/20; H04W 72/1273; H04L 5/00

(52) U.S. Cl. CPC H04W 72/232; H04W 76/20; H04W 72/1273; H04L 5/0051

(57) ABSTRACT

Methods and apparatuses for common TX beam indication and application for UL transmission are disclosed. In one embodiment, a method comprises receiving a higher layer parameter to enable common UL beam for UL transmission for a serving cell; receiving a DCI format 1_1 or 1_2 containing TCI field indicating a TCI state; and determining the common UL beam for UL transmission and the power control parameters for the UL transmission according to the TCI state indicated in the TCI field of the DCI.

### FIELD

The subject matter disclosed herein generally relates to wireless communications, and more particularly relates to methods and apparatuses for common TX beam indication and application for UL transmission.

### BACKGROUND

The following abbreviations are herewith defined, at least some of which are referred to within the following description: New Radio (NR), Very Large Scale Integration (VLSI), Random Access Memory (RAM), Read-Only Memory (ROM), Erasable Programmable Read-Only Memory (EPROM or Flash Memory), Compact Disc Read-Only Memory (CD-ROM), Local Area Network (LAN), Wide Area Network (WAN), User Equipment (UE), Evolved Node B (eNB), Next Generation Node B (gNB), Uplink (UL), Downlink (DL), Central Processing Unit (CPU), Graphics Processing Unit (GPU), Field Programmable Gate Array (FPGA), Orthogonal Frequency Division Multiplexing (OFDM), Radio Resource Control (RRC), User Entity/Equipment (Mobile Terminal), Transmitter (TX), quasi co-location (QCL), reference signal (RS), Downlink Control Information (DCI), Sounding Reference Signal (SRS), SRS resource indicator (SRI), multiple DCI (multi-DCI), Physical Uplink Shared Channel (PUSCH), configured grant PUSCH (CG-PUSCH), Physical Uplink Control Channel (PUCCH), control resource set (CORESET), band width part (BWP), Medium Access Control (MAC), MAC control element (MAC CE), Physical Downlink Shared Channel (PDSCH), Physical Downlink Control Channel (PDCCH), Transmission Configuration Indication (TCI), Demodulation RS (DM-RS), channel state information reference signal (CSI-RS), Receiver (RX), Synchronization Signal Block (SSB), subcarrier space (SCS), transmission reception point (TRP), multiple TRP (multi-TRP or M-TRP), acknowledgment (ACK), pathloss Reference RS (PL-RS), frequency range 2 (FR2).

A TX beam (i.e. UL beam or UL TX beam) for UL transmission refers to the spatial relation for UL transmission. When the UE supports joint DL/UL beam, a DL TCI state can be used for the UL TX beam indication. In particular, the TX beam for UL transmission can be determined by the QCL-TypeD RS configured in the DL TCI state. For example, if the QCL-TypeD RS configured in the DL TCI state is a SSB or a CSI-RS resource, the UE shall transmit the target UL signal using the same spatial domain transmission filter used for the reception of the SSB or CSI-RS resource. When the UE supports separate DL/UL beam, the TX beam for UL transmission can be explicitly configured in a UL TCI state. For example, the TX beam for PUSCH transmission is determined by the spatial relation contained in the UL TCI state.

Dynamic UL TX beam indication is supported for PUSCH transmission scheduled by DCI format 0_1 or 0_2 in NR Release 15, where the TX beam used for transmitting the scheduled PUSCH is determined by the spatialRelationInfo configured for the SRS resource(s) indicated by the SRS resource indicator (SRI) field contained in the DCI format 0_1 or 0_2. Furthermore, the TX beam used for transmitting the scheduled PUSCH is the same as the spatial relation configured for the SRS resource(s) indicated in the SRI field contained in the scheduling DCI format 0_1 or 0_2.

Beam-specific power control is supported for UL transmission in NR Release 15. For example, each spatial relation used for PUCCH resource is associated with a set of power control parameters, and each SRI value is associated with a set of power control parameters to support beam-specific power control for PUSCH transmission.

A default TX beam is also defined in NR Release 16 for PUCCH transmission and PUSCH transmission scheduled by DCI format 0_0 for the case that no explicit TX beam is configured for the PUCCH transmission or no explicit TX beam is indicated for the PUSCH transmission. A common default TX beam can be determined for a BWP according to the TCI indication for the CORESET with lowest ID in the active BWP.

The dynamic beam indication causes higher signaling overhead and larger latency for beam updating. It is desirable that a common TX beam (i.e. common UL beam) for all UL channels is used for transmission of all UL channels to reduce the signaling overhead and latency.

This invention discloses methods and apparatuses for determining common UL beam for all UL channels.

### BRIEF SUMMARY

Methods and apparatuses for common TX beam indication and application for UL transmission are disclosed.

In one embodiment, a method comprises receiving a higher layer parameter to enable common UL beam for UL transmission for a serving cell; receiving a DCI format 1_1 or 1_2 containing TCI field indicating a TCI state; and determining the common UL beam for UL transmission and the power control parameters for the UL transmission according to the TCI state indicated in the TCI field of the DCI.

In one embodiment, for a UE with joint DL/UL beam indication capability, the common UL beam for UL transmission is determined by the QCL-TypeD RS configured in DL TCI state indicated in the TCI field in the DCI format 1_1 or 1_2 with PDSCH assignment. In another embodiment, for a UE with separate DL/UL beam indication capability, the common UL beam for UL transmission is determined by the spatialRelationInfo configured in UL TCI state indicated in the TCI field in the DCI format 1_1 or 1_2 without PDSCH assignment. Each TCI state is associated with a set of power control parameters for both PUCCH transmission and PUSCH transmission, or is associated with two sets of power control parameters including one set of power control parameters for PUCCH transmission and the other set of power control parameters for PUSCH transmission, wherein each set of power control parameters at least includes PL-RS. If no PL-RS is associated with the TCI state which is an indicated DL TCI state, a periodic DL RS with the same ID as the QCL-TypeD RS contained in the indicated DL TCI state is determined as the PL-RS. If no PL-RS is associated with the TCI state which is an indicated UL TCI state, a periodic DL RS with the same ID as the spatialRelationInfo configured in the indicated UL TCI state is determined as the PL-RS.

In another embodiment, for the UE with joint DL/UL beam indication capability, the determined common UL beam for UL transmission and the determined PL-RS apply to all PUSCH transmissions and PUCCH transmissions for the serving cell, starting from the first slot that is Y symbols after the acknowledgment of the PDSCH transmission scheduled by the DCI, wherein Y is predetermined. The actual duration of Y symbols may be determined by 1) a SCS configuration of the active DL BWP for the PDCCH reception carrying the DCI, or 2) a SCS configuration of the active UL BWP for PUCCH or PUSCH transmission carrying the acknowledgement of the PDSCH transmission scheduled by the DCI. In yet another embodiment, for the UE with separate DL/UL beam indication capability, the determined common UL beam for UL transmission and the determined PL-RS apply to all PUSCH transmissions and PUCCH transmissions for the serving cell, starting from the first slot that is Y symbols after the acknowledgment of the DCI, wherein Y is predetermined. The actual duration of Y symbols may be determined by 1) a SCS configuration of the active DL BWP for the PDCCH reception carrying the DCI, or 2′) a SCS configuration of the active UL BWP for PUCCH or PUSCH transmission carrying the acknowledgement of the DCI.

In some embodiment, when the TCI field indicates a TCI codepoint pointing to two TCI states, the common UL beam for PUSCH transmission and PUCCH transmission without multi-TRP repetition and the power control parameters are determined according to a first TCI state of the two TCI states for a UE with joint DL/UL beam indication capability. If a higher layer parameter CORESETPoolIndex is configured for each CORESET, the TCI state indicated in the TCI field of the DCI only applies to PUSCH transmission scheduled by a UL DCI transmitted from CORESET configured with the same CORESETPoolIndex value as that configured for the CORESET transmitting the DCI; CG-PUSCH associated with the same CORESETPoolIndex value as that configured for the CORESET transmitting the DCI; and PUCCH resources associated with the same CORESETPoolIndex value as that configured for the CORESET transmitting the DCI.

In some embodiment, the method may further comprise receiving a configuration of one or more cell lists each of which is composed of one or multiple serving cells, wherein the common UL beam for UL transmission is enabled for all serving cells in a cell list containing the serving cell. If the TCI state is indicated in the TCI field of the DCI on the serving cell with a serving cell ID, when the serving cell ID is configured as part of a cell list, the TCI state with the same ID indicated in the TCI field applies to all serving cells in the cell list for determining the common UL beam for UL transmission and the power control parameters for the UL transmission, starting from the first slot that is Y symbols after the acknowledgment of the DCI or of the PDSCH transmission scheduled by the DCI, wherein Y is predetermined. The actual duration of Y symbols may be determined by the smallest of the SCS configurations of the active DL BWPs of all serving cells in the cell list.

In another embodiment, a remote unit comprises a receiver that receives a higher layer parameter to enable common UL beam for UL transmission for a serving cell, and receives a DCI format 1_1 or 1_2 containing TCI field indicating a TCI state; and a processor that determines the common UL beam for UL transmission and the power control parameters for the UL transmission according to the TCI state indicated in the TCI field of the DCI.

In one embodiment, a method comprises transmitting a higher layer parameter to enable common UL beam for UL transmission for a serving cell; transmitting a DCI format 1_1 or 1_2 containing TCI field indicating a TCI state; and determining the common UL beam for UL transmission and the power control parameters for the UL transmission according to the TCI state indicated in the TCI field of the DCI.

In yet another embodiment, a base unit comprises a transmitter that transmits a higher layer parameter to enable common UL beam for UL transmission for a serving cell, and receives a DCI format 1_1 or 1_2 containing TCI field indicating a TCI state; and a processor that determines the common UL beam for UL transmission and the power control parameters for the UL transmission according to the TCI state indicated in the TCI field of the DCI.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments, and are not therefore to be considered to be limiting of scope, the embodiments will be described and explained with additional specificity and detail through the use of the accompanying drawings, in which:

FIG. 1 illustrates multi-beam coverage for a cell;

FIG. 2 illustrates an example of common UL beam determination;

FIG. 3 illustrates an example of common TCI activation/deactivation MAC CE;

FIG. 4 illustrates an example of common UL TCI activation/deactivation MAC CE;

FIG. 5 illustrates an example of common UL and DL TCI activation/deactivation MAC CE;

FIG. 6 is a schematic flow chart diagram illustrating an embodiment of a method;

FIG. 7 is a schematic flow chart diagram illustrating a further embodiment of a method; and

FIG. 8 is a schematic block diagram illustrating apparatuses according to one embodiment.

### DETAILED DESCRIPTION

As will be appreciated by one skilled in the art that certain aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may generally all be referred to herein as a “circuit”, “module” or “system”. Furthermore, embodiments may take the form of a program product embodied in one or more computer readable storage devices storing machine-readable code, computer readable code, and/or program code, referred to hereafter as “code”. The storage devices may be tangible, non-transitory, and/or non-transmission. The storage devices may not embody signals. In a certain embodiment, the storage devices only employ signals for accessing code.

Certain functional units described in this specification may be labeled as “modules”, in order to more particularly emphasize their independent implementation. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but, may include disparate instructions stored in different locations which, when joined logically together, include the module and achieve the stated purpose for the module.

Indeed, a module of code may contain a single instruction, or many instructions, and may even be distributed over several different code segments, among different programs, and across several memory devices. Similarly, operational data may be identified and illustrated herein within modules and may be embodied in any suitable form and organized within any suitable type of data structure. This operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing code. The storage device may be, for example, but need not necessarily be, an electronic, magnetic, optical, electromagnetic, infrared, holographic, micromechanical, or semiconductor system, apparatus, or device, or any suitable combination of the foregoing.

A non-exhaustive list of more specific examples of the storage device would include the following: an electrical connection having one or more wires, a portable computer diskette, a hard disk, random access memory (RAM), read-only memory (ROM), erasable programmable read-only memory (EPROM or Flash Memory), portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Code for carrying out operations for embodiments may include any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may be executed entirely on the user's computer, partly on the user's computer, as a stand-alone software package, partly on the user's computer and partly on a remote computer or entirely on the remote computer or server. In the very last scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment”, “an embodiment”, or similar language means that a particular feature, structure, or characteristic described in connection with the embodiment is included in at least one embodiment. Thus, appearances of the phrases “in one embodiment”, “in an embodiment”, and similar language throughout this specification may, but do not necessarily, all refer to the same embodiment, but mean “one or more but not all embodiments” unless expressly specified otherwise. The terms “including”, “comprising”, “having”, and variations thereof mean “including but are not limited to”, unless otherwise expressly specified. An enumerated listing of items does not imply that any or all of the items are mutually exclusive, otherwise unless expressly specified. The terms “a”, “an”, and “the” also refer to “one or more” unless otherwise expressly specified.

Furthermore, described features, structures, or characteristics of various embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid any obscuring of aspects of an embodiment.

Aspects of different embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which are executed via the processor of the computer or other programmable data processing apparatus, create means for implementing the functions specified in the schematic flowchart diagrams and/or schematic block diagrams for the block or blocks.

The code may also be stored in a storage device that can direct a computer, other programmable data processing apparatus, or other devices, to function in a particular manner, such that the instructions stored in the storage device produce an article of manufacture including instructions which implement the function specified in the schematic flowchart diagrams and/or schematic block diagrams block or blocks.

The code may also be loaded onto a computer, other programmable data processing apparatus, or other devices, to cause a series of operational steps to be performed on the computer, other programmable apparatus or other devices to produce a computer implemented process such that the code executed on the computer or other programmable apparatus provides processes for implementing the functions specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that in some alternative implementations, the functions noted in the block may occur out of the order noted in the Figures. For example, two blocks shown in succession may substantially be executed concurrently, or the blocks may sometimes be executed in the reverse order, depending upon the functionality involved. Other steps and methods may be conceived that are equivalent in function, logic, or effect to one or more blocks, or portions thereof, to the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each Figure may refer to elements of proceeding figures. Like numbers refer to like elements in all figures, including alternate embodiments of like elements.

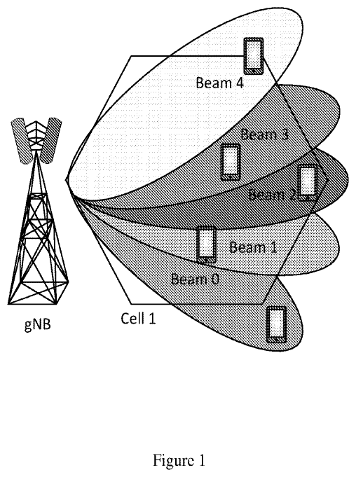

FIG. 1 illustrates multi-beam coverage for a cell. As illustrated in FIG. 1, a serving cell 1 is covered by 5 different beams (i.e. Beam 0, Beam 1, Beam 2, Beam 3 and Beam 4) transmitted by the gNB. If a UE is located in the coverage area of a certain beam, it is reasonable for the UE to use the same beam for reception of DL control and data channel. For example, if the UE is in the coverage of Beam 2 shown in FIG. 1, the UE can receive all PDCCH transmissions from all CORESETs other than CORESET #0 (CORESET #0 can be used for system information scheduling with dedicated beam), and all PDSCH transmissions in all BWPs in a carrier for the cell using a common beam (i.e. Beam 2). Note that each CORESET identifies a set of time-frequency resources for PDCCH transmission, and that each BWP configures a partial band of a carrier with dedicated subcarrier space. When the UE moves from the coverage of one beam to the coverage of another beam, the common beam should also switch to the other beam. For example, when the UE moves from the coverage of Beam 2 to the coverage of Beam 3, the common beam for DL reception should switch to Beam 3 from Beam 2.

When the UE supports joint DL/UL beam indication capability, it is reasonable that the above described common beam can be used as, in addition to common DL beam, common UL beam for all UL transmissions (i.e. for all UL channels), e.g., PUSCH transmissions and PUCCH transmissions.

In the condition that a UE supports separate DL/UL beam indication capability, the DL beam and the UL beam can be picked from different beam sets. However, suppose that the UE is in a certain position, it is reasonable that the UE transmits all UL channels using a same UL beam, i.e. a common UL beam. For the UE with separate DL/UL beam indication capability, the common UL beam should be configured separately from the common DL beam.

In order to implement common UL beam (or common UL beam change) for UL transmission, the following procedures are necessary: UE should be configured to support common UL beam for UL transmission; the common UL beam (or the changed common UL beam) should be indicated to the UE; the UE determines when the (changed) common UL beam applies, i.e. when the (changed) common UL beam is used for UL transmission; and the UE determines power control parameters for the UL transmission (e.g. PUSCH transmission and PUCCH transmission).

According to a first embodiment, the network explicitly indicates that the UE (either the UE with joint DL/UL beam indication capability or the UE with separate DL/UL beam indication capability) supports common UL beam for all UL channels. The indication can be made by a RRC parameter. For example, a higher layer parameter enable CommonBeamForUL can be set as ‘enabled’ to indicate the UE that common UL beam for UL transmission is configured. In particular, the UE receives from the network (e.g. gNB) the higher layer parameter enable CommonBeamForUL set as ‘enabled’ to enable common UL beam for UL transmission for a cell.

According to a second embodiment, the common UL beam for UL transmission is indicated to the UE by a Transmission Configuration Indication (TCI) field contained in DL DCI (e.g. DCI format 1_1 or 1_2).

The TCI field is optionally contained in DL DCI format 1_1 and 1_2. A higher layer parameter tci-PresentInDCl configures whether the TCI field is contained in DCI format 1_1 for a CORESET. When the higher layer parameter tci-PresentInDCl is set to ‘enabled’ for a CORESET, the TCI field is contained in DCI format 1_1 transmitted from the CORESET; while when the higher layer parameter tci-PresentInDCl is set to ‘disabled’ for a CORESET, the TCI field is not contained in DCI format 1_1 transmitted from the CORESET. A higher layer parameter tci-PresentDCI-1-2-r16 configures whether the TCI field is contained in DCI format 1_2 for a CORESET. When the higher layer parameter tci-PresentDCI-1-2-r16 is configured for a CORESET, the TCI field is contained in DCI format 1_2 transmitted from the CORESET; while when the higher layer parameter tci-PresentDCI-1-2-r16 is not configured for a CORESET, the TCI field is not contained in DCI format 1_2 transmitted from the CORESET. In particular, at least for one CORESET, tci-PresentInDCl should be set as ‘enabled’ to indicate that TCI field is contained in the DCI format 1-1 transmitted from the one CORESET; or tci-PresentDCI-1-2-r16 should be configured to indicate that TCI field is contained in the DCI format 1-2 transmitted from the one CORESET. For other CORESETs, tci-PresentInDCl can be set as ‘disabled’, or tci-PresentDCI-1-2-r16 can be not configured.

As a whole, the TCI field shall be included in a DCI format 1_1 transmitted from at least one CORESET, or the TCI field shall be included in a DCI format 1_2 transmitted from at least one CORESET, so that the common UL beam for UL transmission can be indicated to the UE by the TCI field contained in DL DCI (DCI format 1_1 or 1_2) transmitted from the at least one CORESET.

Depending on different UE capabilities (i.e. the UE with joint DL/UL beam indication capability, and the UE with separate DL/UL beam indication capability), the common UL beam for UL transmission is indicated slightly differently.

DL DCI format 1_1 or 1_2 is generally used for scheduling a PDSCH transmission. The TCI field contained in DL DCI format 1_1 or 1_2 indicates a TCI state (i.e. a DL TCI state) for the reception of the scheduled PDSCH transmission. For the UE with joint DL/UL beam indication capability, the DL TCI state that is used to determine the DL beam can be used to determine the UL beam. Therefore, the DL TCI state indicated in the TCI field determines a common UL beam for UL transmission for the UE with joint DL/UL beam indication capability.

The DL TCI state can be configured by the following RRC signaling:

TCI state
The IE TCI state associates one or two DL reference signals
with a corresponding quasi-
colocation (QCL) type.

TCI state information element
-- ASN1START
-- TAG-TCI STATE-START

| | |
|---|---|
| TCI state ::= | SEQUENCE { |
| TCI stateId | TCI stateId, |
| qcl-Type1 | QCL-Info, |
| qcl-Type2 | QCL-Info |

OPTIONAL, -- Need R
...
}

| | |
|---|---|
| QCL-Info ::= | SEQUENCE { |
| cell | ServCellIndex |

OPTIONAL, -- Need R

| | |
|---|---|
| bwp-Id | BWP-Id |

OPTIONAL, -- Cond CSI-RS-Indicated

| | |
|---|---|
| referenceSignal | CHOICE { |
| csi-rs | NZP-CSI-RS-ResourceId, |
| ssb | SSB-Index |
| }, | ENUMERATED {typeA, typeB, typeC, typeD}, |

```
  qcl-Type
  ...
}
-- TAG-TCI STATE-STOP
-- ASN1STOP
```

It can be seen that each DL TCI state contains parameters for configuring a quasi co-location (QCL) relationship between one or two downlink reference signals and the DM-RS ports of the PDSCH, the DM-RS port of PDCCH or the CSI-RS port(s) of a CSI-RS resource. The quasi co-location relationship is configured by the higher layer parameter qcl-Type1 for the first DL RS, and qcl-Type2 for the second DL RS (if configured). For the case of two DL RSs, the QCL types shall not be the same, regardless of whether the references are to the same DL RS or different DL RSs. The quasi co-location types corresponding to each DL RS are given by the higher layer parameter qcl-Type in QCL-Info and may take one of the following values:
‘QCL-TypeA’: {Doppler shift, Doppler spread, average delay, delay spread}
‘QCL-TypeB’: {Doppler shift, Doppler spread}
‘QCL-TypeC’: {Doppler shift, average delay}
‘QCL-TypeD’: {Spatial Rx parameter}

M (up to 128, which depends on UE capability) DL TCI states can be configured for a UE in a carrier (i.e. in a cell) by for example the above-described RRC signaling. The UE receives an activation command (e.g. MAC CE) used to map up to 8 DL TCI states to the codepoint indicated in the TCI field of a DL DCI (e.g. DCI format 1_1 or 1_2) in one DL BWP of a serving cell. When a UE supports two DL TCI states (in particular, one or two DL TCI states) pointed to by a codepoint indicated in the TCI field, the UE may receive an activation command used to map up to 8 combinations of one or two DL TCI states to the codepoint indicated in the TCI field. Hereinafter, when the codepoint (or TCI codepoint) indicated in the TCI field points to only one TCI state, the one TCI state can be referred to as “the TCI state indicated in the TCI field”.

The common UL beam (i.e. common spatial relation) for UL transmission is determined by the QCL-TypeD RS configured in the DL TCI state indicated in the TCI field (i.e. pointed to by the codepoint indicated in the TCI field), i.e. the UE transmits the UL signal with the same spatial domain transmission filter as that used for the reception of the QCL-TypeD RS configured in the indicated DL TCI state, for the UE with joint DL/UL beam indication capability.

In summary, for the UE with joint DL/UL beam indication capability, the DL TCI state indicated in the TCI field contained in DCI format 1_1 or 1_2 with PDSCH assignment (that is, the DCI format 1_1 or 1_2 schedules a PDSCH transmission) determines the common UL beam (i.e. common spatial relation) for UL transmission. In particular, the common UL beam (i.e. the common spatial relation) is determined by the QCL-TypeD RS contained in the indicated DL TCI state (which can be also used as joint DL/UL TCI state).

According to a variety of the second embodiment, for the UE with separate DL/UL beam indication capability, the TCI field contained in DCI format 1_1 or 1_2 without PDSCH assignment (that is, the DCI format 1_1 or 1_2 does not schedule a PDSCH transmission) indicates a UL TCI state that determines the common UL beam for UL transmission. For the UE with separate DL/UL beam indication capability, the DL beam and the UL beam shall be determined differently, i.e. by a DL TCI state and a UL TCI state, respectively. Therefore, the variety of the second embodiment proposes that the TCI field contained in DCI format 1_1 or 1_2 without PDSCH assignment indicates a UL TCI state. The common UL beam (i.e. common spatial relation) for UL transmission is determined by the spatialRelationInfo configured in the indicated UL TCI state. The spatialRelationInfo can be set as for example a SSB resource or a CSI-RS resource or a SRS resource. When the spatialRelationInfo is set as an SRS resource, the UE shall transmit the target UL signal with the same spatial domain transmission filter as that used for the transmission of the SRS resource. On the other hand, when spatialRelationInfo is a downlink resource (e.g. SSB resource or CSI-RS resource), the UE shall transmit the target UL signal with the same spatial domain transmission filter as that used for the reception of the downlink resource (i.e. the SSB resource or the CSI-RS resource).

According to a third embodiment, when the UE receives a DL DCI (e.g. DCI format 1_1 or 1_2) containing the TCI field, the UE determines common UL beam (i.e. common spatial relation) for UL transmission according to the TCI state indicated in the TCI field.

According to the third embodiment, for the UE with joint DL/UL beam indication capability, the DL TCI state indicated in the TCI field of the DCI format 1_1 or 1_2 with PDSCH assignment (in particular, the QCL-TypeD RS configured in the indicated DL TCI state) determines the common UL beam (i.e. common spatial relation) for UL transmission. In addition, the determined common UL beam (i.e. common spatial relation) for UL transmission is applied (i.e. the determined common beam is used for UL transmission), starting from the first slot that is Y symbols after the acknowledgment of the PDSCH transmission scheduled by the DCI containing the TCI field indicating common UL beam, wherein Y is predetermined, which means that Y is a fixed specified value or Y is configured by RRC parameter according to UE capability. Considering that different subcarrier spaces (SCSs) may be configured for different BWPs in a carrier, and that symbol durations correspond to different SCSs are different, a specific SCS configuration should be determined to determine the actual duration of Y symbols for the application of the common UL beam. For example, when SCS=15 kHz is configured for the active DL BWP and SCS=30 kHz is configured for the active UL BWP, the symbol duration of a DL symbol is twice of the symbol duration of a UL symbol. It is necessary to specify the SCS used to determine the actual duration of Y symbols. Two alternative specific SCS configurations for determining the actual duration of Y symbols are proposed: 1) the SCS configuration of the active DL BWP for the PDCCH reception carrying the DCI containing TCI field indicating common UL beam; and 2) the SCS configuration of the active UL BWP for the PUCCH or PUSCH transmission carrying the ACK corresponding to the PDSCH transmission scheduled by the DCI containing TCI field indicating common UL beam.

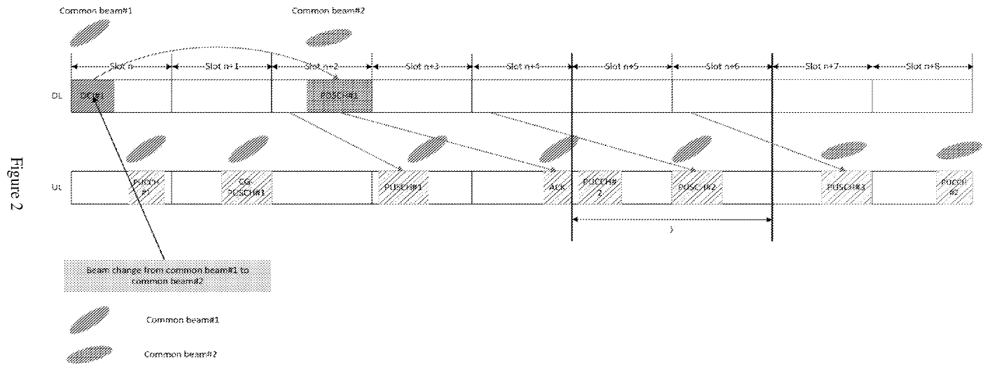

FIG. 2 illustrates an example of common UL beam (i.e. common spatial relation) determination for the UE with joint DL/UL beam indication capability. Suppose M (up to 128) DL TCI states are configured for a UE in a carrier by RRC signaling, and N (up to 8) out of them are activated by a dedicated MAC CE. A higher layer parameter enableCommonBeamForUL is configured and set as ‘enabled’. The higher layer parameter tci-PresentInDCl is set as ‘enabled’ for at least one CORESET, e.g., CORESET #1, configured in the current active BWP. Accordingly, the DCI with format 1_1 transmitted from CORESET #1 contains TCI field. The TCI state indicated in the TCI field contained in DCI format 1_1 with PDSCH assignment (i.e. scheduling a PDSCH transmission) transmitted from CORESET #1 determines the common UL beam (i.e. common spatial relation) for UL transmission (may also determine a common DL beam for DL reception).

As shown in FIG. 2, common beam #1 (i.e. old beam) is used as the common beam for UL transmission and DL reception before slot n. The UE detects a common beam change to common beam #2 (i.e. new beam) determined by the DL TCI state indicated in the TCI field contained in DCI #1 received in slot n. DCI #1 also schedules a PDSCH transmission PDSCH #1. The UE can receive PDSCH #1 scheduled by DCI #1 using the new common beam #2. The UE reports the acknowledgment (ACK) of PDSCH #1 in slot n+4. The indicated common beam #2 (i.e. new beam) will be applied to (i.e. used for transmitting) all UL channels, starting from slot n+7, i.e., the first slot that is Y symbols after the acknowledgment (the end of slot n+4, or the start of slot n+5) of the PDSCH transmission scheduled by the DCI (e.g. DCI #1) indicating a common beam change (i.e. common UL beam change). The actual duration of Y symbols is determined by 1) the SCS configuration of the active DL BWP for the PDCCH reception carrying the DCI (e.g. DCI #1) containing TCI field indicating (new) common UL beam; or 2) the SCS configuration of the active UL BWP for the PUCCH or PUSCH transmission carrying the ACK corresponding to the PDSCH transmission scheduled by the DCI (e.g. DCI #1) containing TCI field indicating (new) common UL beam. In the example of FIG. 2, Y=28 symbols (equal to 2 slots). So, the common beam #1 (i.e. old beam) is still valid for all UL channels before slot n+7. For example, as illustrated in FIG. 2, all of PUCCH #1 (in slot n), CG-PUSCH #1 (in slot n+1), PUSCH #1 (in slot n+3), ACK (in slot n+4), PUCCH #2 (in slot n+5), and PUSCH #2 (in slot n+6) are transmitted by using common beam #1 (i.e. old beam). On the other hand, for all UL transmissions starting from slot n+7, the common beam #2 (i.e. new beam) is valid. For example, PUSCH #3 (in slot n+7) and PUCCH #2 (in slot n+8) are transmitted by using common beam #2 (i.e. new beam).

According to a variety of the third embodiment, for the UE with separate DL/UL beam indication capability, the UL TCI state indicated in the TCI field of the DCI format 1_1 or 1_2 without PDSCH assignment (in particular, the spatialRelationInfo configured in the indicated UL TCI state) determines the common UL beam (i.e. common spatial relation) for UL transmission. In addition, the determined common UL beam (i.e. common spatial relation) for UL transmission is applied (i.e. the determined common UL beam is used for UL transmission), starting from the first slot that is Y symbols after the acknowledgment of the DCI containing TCI field indicating common UL beam, wherein Y is predetermined, which means that Y is a fixed specified value or Y is configured by RRC parameter according to UE capability. Two alternative specific SCS configurations for determining the actual duration of Y symbols are proposed: 1) the SCS configuration of the active DL BWP for the PDCCH reception carrying the DCI containing TCI field indicating common UL beam change; and 2′) the SCS configuration of the active UL BWP for the PUCCH or PUSCH transmission carrying the ACK corresponding to the DCI containing TCI field indicating common UL beam change.

For both the UE with joint DL/UL beam indication capability and the UE with separate DL/UL beam indication capability, the determined common UL beam (i.e. common spatial relation) for UL transmission applies to the following UL channels:
PUSCH scheduled by DCI format 0_0 or 0_1 or 0_2;
Type 1 and type 2 configured grant PUSCH (CG-PUSCH); and
Dedicated PUCCH.

According to a fourth embodiment, a set of power control parameters is determined for each UL transmission, e.g. PUSCH transmission or PUCCH transmission, for which the common UL beam for UL transmission is determined. Each common UL beam can be associated with a set of power control parameters for both the PUSCH transmission and the PUCCH transmission. Alternatively, each common UL beam can be associated with two separate sets of power control parameters including one set of power control parameters for the PUSCH transmission and the other set of power control parameters for the PUCCH transmission. The association can be configured by RRC signaling or configured by MAC CE.

Each set of power control parameters includes at least pathlossReferenceRS (PL-RS) used for pathloss estimation, and may further include P0, alpha and closed loop index, where P0 configures the target receive power, alpha configures the factor for pathloss compensation.

If only PL-RS is included in a set of power control parameters, i.e. only PL-RS is associated with each common UL beam, the other power control parameters including P0, alpha and closed loop index can be obtained or configured by the following manners.

For PUSCH scheduled by a DCI, the other power control parameters can be obtained by SRI field contained in the scheduling DCI.

For CG-PUSCH resource, the other power control parameters can be configured by RRC signaling.

For PUCCH resource, the other power control parameters can be configured by RRC signaling.

If the PL-RS is not associated with the common UL beam, the UE uses a periodic DL RS as the PL-RS. In particular, for the UE with joint DL/UL beam indication capability, the PL-RS is determined as the periodic DL RS with the same ID as the QCL-TypeD RS contained in the DL TCI state indicated in the TCI field in DCI format 1_1 or 1_2. For UE with separate DL/UL beam indication capability, the PL-RS is determined by the periodic DL RS with the same ID as spatialRelationInfo contained in the UL TCI state indicated in the TCI field in DCI format 1_1 or 1_2.

Suppose that the UE has separate UL/DL beam indication capability, and that separate TCI state pools for UL and DL are configured by RRC signaling respectively. An example of the RRC signaling for UL TCI state is shown as below.

| | |
|---|---|
| UL TCI-State ::= | SEQUENCE { |
| UL-tci-StateId | UL-TCI-StateId, |
| spatialRelationInfo | CHOICE { |
| csi-rs | NZP-CSI-RS-ResourceId, |
| ssb | SSB-Index |
| srs | SRS-ResourceId |

},

| | |
|---|---|
| PowerControlForPUCCH | SEQUENCE { |
| pucch-PathlossReferenceRS-Id | PUCCH-PathlossReferenceRS-Id, |
| p0-PUCCH-Id | P0-PUCCH-Id, |
| closedLoopIndex | ENUMERATED {i0, i1} |

}

| | |
|---|---|
| PowerControlForPUSCH | SEQUENCE { |
| pusch-PathlossReferenceRS-Id | PUSCH-PathlossReferenceRS-Id, |
| P0-PUSCH-AlphaSetId | P0-PUSCH-AlphaSetId |
| closedLoopIndex | ENUMERATED {i0, i1} |

}
}

It can be seen that the UL TCI state is configured with a spatial relation, a first set of power control parameters including PL-RS, P0 and closed loop index configured for PUCCH, and a second set of power control parameters including PL-RS, P0, alpha and closed loop index configured for PUSCH. The UE determines the common UL beam for UL transmission according to the spatialRelationInfo configured in the indicated UL TCI state, and determines the transmit power for PUCCH according to the first set of power control parameters configured by PowerControlForPUCCH, or determines the transmit power for PUSCH according to the second set of power control parameters configured by PowerControlForPUSCH.

Multi-TRP is supported in NR Release 17. In particular, single-DCI based multi-TRP DL transmission and multi-DCI based multi-TRP DL transmission are supported.

The common UL beam is determined by DL TCI state indicated in the TCI field of DL DCI format 1_1 or 1_2 for the UE with joint DL/UL beam indication capability. A fifth embodiment describes the common UL beam indication in scenario of single-DCI based multi-TRP DL transmission, for the UE with joint DL/UL beam indication capability.

In scenario of single-DCI based multi-TRP DL transmission, one DL DCI transmitted from one TRP may schedule a PDSCH transmission from different TRPs (e.g. two TRPs) using different beams (e.g. two beams) in FR2, where the two beams are determined by two DL TCI states pointed to by TCI codepoint indicated in the TCI field contained in the scheduling DCI.

According to the fifth embodiment, the network explicitly indicates that the UE with joint DL/UL beam indication capability supports common UL beam for all UL channels, with the same manner as described in the first embodiment. That is, the UE receives from the network (e.g. gNB) the higher layer parameter enableCommonBeamForUL set as ‘enabled’ to enable common UL beam for UL transmission.

According to the fifth embodiment, the common UL beam for all UL channels is determined by the DL TCI state indicated in the TCI field contained in DL DCI (e.g. DCI format 1_1 or 1_2) with PDSCH assignment, with the same manner as described for the UE with joint DL/UL beam indication capability in the second embodiment. In the scenario of single TRP according to the second embodiment, the DL TCI state indicated in the TCI field includes one QCL-TypeD RS determining one common UL beam for the UE with joint DL/UL beam indication capability. In the scenario of single-DCI based multi-TRP DL transmission, the TCI field of the DL DCI indicates a TCI codepoint that points to one or two TCI states, each of which includes one QCL-TypeD RS determining one common beam.

Only one common UL beam is needed for UL transmission without multi-TRP based PUSCH or PUCCH repetition for a UE with joint DL/UL beam indication capability. In view of the above, if the TCI field of the DL DCI indicates a TCI codepoint that points one DL TCI state, the common UL beam for UL transmission is determined with the same manner for the UE with joint DL/UL beam indication capability described in the third embodiment. That is, the QCL-TypeD RS configured in the one DL TCI state pointed to by the TCI codepoint indicated in the TCI field determines the common UL beam for UL transmission. On the other hand, if the TCI field of the DL DCI indicates a TCI codepoint that points two DL TCI states, the common UL beam for UL transmission is determined by one DL TCI state (e.g. the first DL TCI state) pointed to by the TCI codepoint indicated in the TCI field. That is, the QCL-TypeD RS configured in the first DL TCI state pointed to by the TCI codepoint indicated in the TCI field determines the common UL beam for UL transmission.

According to the fifth embodiment, the power control parameters are determined with the same manner for the UE with joint DL/UL beam indication capability described in the fourth embodiment. For example, one set of power control parameters that is associated with the first DL TCI state pointed to by the TCI codepoint indicated in the TCI field may be determined as the power control parameters for both the PUCCH transmission and the PUSCH transmission, or two sets of power control parameters that are associated with the first DL TCI state pointed to by the TCI codepoint indicated in the TCI field may be determined as the power control parameters for the PUCCH transmission and for the PUSCH transmission, respectively.

A sixth embodiment describes the common UL beam indication in scenario of multi-DCI based multi-TRP DL transmission.

In scenario of multi-DCI based multi-TRP DL transmission, a higher layer parameter CORESETPoolIndex can be configured for each CORESET for TRP differential, where CORESETPoolIndex=0 is configured for all CORESET(s) configured for one TRP (e.g. TRP #1), and CORESETPoolIndex=1 is configured for all CORESET(s) configured for the other TRP (e.g. TRP #2).

According to the sixth embodiment, for the UE with joint DL/UL beam indication capability, the network explicitly indicates that the UE supports common UL beam for all UL channels, with the same manner as described in the first embodiment. That is, the UE receives from the network (e.g. gNB) the higher layer parameter enable CommonBeamForUL set as ‘enabled’ to enable common UL beam for UL transmission.

According to the sixth embodiment, the common UL beam for all UL channels is indicated in the TCI field contained in DL DCI (e.g. DCI format 1_1 or 1_2) with PDSCH assignment, with the same manner for the UE with joint DL/UL beam indication capability as described in the second embodiment. In particular, the TCI field of the DL DCI indicates a TCI codepoint that points to one DL TCI state, which includes one QCL-TypeD RS determining the common UL beam.

According to the sixth embodiment, different (e.g. two) DL TCI state pools can be configured in a carrier and be associated with different (e.g. two) CORESETPoolIndex values, or one DL TCI state pool is configured in a carrier and two different subsets of the one DL TCI state pool are activated and are associated with two CORESETPoolIndex values respectively. So, the DL TCI state indicated in the TCI field of the DL DCI may be mapped to one of different (e.g. two) DL TCI states depending on the CORESETPoolIndex value associated with the CORESET transmitting the PDCCH carrying the DL DCI. That is, when CORESETPoolIndex=0 is associated with the CORESET transmitting the PDCCH carrying a DL DCI, the DL TCI state indicated in the TCI field of the DL DCI is mapped to a DL TCI state with the same ID contained in a DL TCI state pool (or a subset of the DL TCI state pool) associated with the same CORESETPoolIndex=0, and the power control parameters are also determined according to the DL TCI state with the same ID contained in the DL TCI state pool (or a subset of the DL TCI state pool) associated with the same CORESETPoolIndex=0. Similarly, when CORESETPoolIndex=1 is associated with the CORESET transmitting the PDCCH carrying a DL DCI, the DL TCI state indicated in the TCI field of the DL DCI is mapped to a DL TCI state with the same ID contained in a DL TCI state pool (or a subset of the DL TCI state pool) associated with the same CORESETPoolIndex=1, and the power control parameters are also determined according to the DL TCI state with the same ID contained in the DL TCI state pool (or a subset of the DL TCI state pool) associated with the same CORESETPoolIndex=1.

So, the common UL beam determined by the QCL-TypeD RS configured in the DL TCI state indicated in the TCI field of a DL DCI (format 1_1 or 1_2) indicating common UL beam and the power control parameters determined according to the indicated DL TCI state only apply to the following channels:

PUSCH transmission scheduled by a UL DCI transmitted from CORESET configured with the same CORESETPoolIndex value as that configured for the CORESET transmitting the DL DCI indicating the common UL beam;

CG-PUSCH associated with the same CORESETPoolIndex value as that configured for the CORESET transmitting the DL DCI indicating the common UL beam (note that CG-PUSCH activated by a DCI transmitted from CORESET configured with the same CORESETPoolIndex value as that configured for the CORESET transmitting the DL DCI indicating the common UL beam can be also referred to as ‘CG-PUSCH associated with the same CORESETPoolIndex value as that configured for the CORESET transmitting the DL DCI indicating the common UL beam’); and

PUCCH resources associated with the same CORESETPoolIndex value as that configured for the CORESET transmitting the DL DCI indicating the common UL beam. According to a variety of the sixth embodiment, for the UE with separate DL/UL

beam indication capability, the network explicitly indicates that the UE supports common UL beam for all UL channels, with the same manner as described in the first embodiment. That is, the UE receives from the network (e.g. gNB) the higher layer parameter enableCommonBeamForUL set as ‘enabled’ to enable common UL beam for UL transmission.

According to the variety of the sixth embodiment, the common UL beam for all UL channels is determined by the UL TCI state indicated in the TCI field contained in DL DCI (e.g. DCI format 1_1 or 1_2) without PDSCH assignment, with the same manner for the UE with separate DL/UL beam indication capability as described in the variety of the second embodiment. In particular, the TCI field of the DL DCI indicates a TCI codepoint that points to one UL TCI state, the spatialRelationInfo configured for which determines the common UL beam.

According to the variety of the sixth embodiment, different (e.g. two) UL TCI state pools can be configured in a carrier and be associated with different (e.g. two) CORESETPoolIndex values, or one UL TCI state pool is configured in a carrier and two different subsets of the one UL TCI state pool are activated and are associated with two CORESETPoolIndex values respectively. So, the UL TCI state indicated in the TCI field of the DL DCI may be mapped to one of different (e.g. two) UL TCI states depending on the CORESETPoolIndex value associated with the CORESET transmitting the PDCCH carrying the DL DCI. That is, when CORESETPoolIndex=0 is associated with the CORESET transmitting the PDCCH carrying a DL DCI, the UL TCI state indicated in the TCI field of the DL DCI is mapped to a UL TCI state with the same ID contained in a UL TCI state pool (or a subset of the UL TCI state pool) associated with the same CORESETPoolIndex=0, and the power control parameters are also determined according to the UL TCI state with the same ID contained in the UL TCI state pool (or a subset of the UL TCI state pool) associated with the same CORESETPoolIndex=0. Similarly, when CORESETPoolIndex=1 is associated with the CORESET transmitting the PDCCH carrying a DL DCI, the UL TCI state indicated in the TCI field of the DL DCI is mapped to a UL TCI state with the same ID contained in a UL TCI state pool (or a subset of the UL TCI state pool) associated with the same CORESETPoolIndex=1, and the power control parameters are also determined according to the UL TCI state with the same ID contained in the UL TCI state pool (or a subset of the UL TCI state pool) associated with the same CORESETPoolIndex=1.

So, the common UL beam determined by spatialRelationInfo configured for the UL TCI state indicated in the TCI field of a DL DCI (format 1_1 or 1_2) indicating common UL beam and the power control parameters determined according to the indicated UL TCI state only apply to the following channels:
PUSCH transmission scheduled by a UL DCI transmitted from CORESET configured with the same CORESETPoolIndex value as that configured for the CORESET transmitting the DL DCI indicating the common UL beam;
CG-PUSCH associated with the same CORESETPoolIndex value as that configured for the CORESET transmitting the DL DCI indicating the common UL beam (including ‘CG-PUSCH activated by a DCI transmitted from CORESET configured with the same CORESETPoolIndex value as that configured for the CORESET transmitting the DL DCI indicating the common UL beam’); and
PUCCH resources associated with the same CORESETPoolIndex value as that configured for the CORESET transmitting the DL DCI indicating the common UL beam.

A seventh embodiment describes simultaneous common UL beam indication for multiple cells, for the UE with joint DL/UL beam indication capability.

One or more cell lists, each of which contains multiple cells, can be configured for a UE with joint DL/UL beam indication capability for simultaneous common UL beam indication for all cells in a cell list. Note that the UE has joint DL/UL beam indication capability for all cells contained in the cell list. For example, a UE with joint DL/UL beam indication capability is configured with 8 serving cells. Serving cells with indices 0, 1, 2 and 3 can be configured to belong to one cell list, e.g., simultaneousCommonbeam-UpdatedList1-r17, and serving cells with indices 4, 5, 6 and 7 can be configured to belong to another cell list, e.g., simultaneousCommonbeam-UpdatedList2-r17.

According to the seventh embodiment, the network explicitly indicates that the UE supports common UL beam for all UL channels, with the same manner as described in the first embodiment. That is, the UE receives from the network (e.g. gNB) the higher layer parameter enableCommonBeamForUL set as ‘enabled’ to enable common UL beam for UL transmission for a carrier used by a serving cell with a serving cell ID. When the serving cell ID is configured as part of a cell list, simultaneous common UL beam updating for all serving cells in the cell list is supported.

According to the seventh embodiment, the common UL beam for all UL channels is determined by the DL TCI state indicated in the TCI field contained in DCI (e.g. DCI format 1_1 or 1_2) with PDSCH assignment (in particular by the QCL-TypeD RS configured in the indicated DL TCI state), with the same manner as described in the second embodiment. If a common UL beam is determined by the QCL-TypeD RS configured in the DL TCI state indicated in the TCI field of a DCI format 1_1 or 1_2 with PDSCH assignment for a serving cell with a serving cell ID, when the serving cell ID is configured as part of a cell list, the common UL beam applies to all serving cells in the cell list. That is, the DL TCI state with the same TCI-stateId indicated in the TCI field of the DCI format 1_1 or 1_2 with PDSCH assignment applies to all serving cells in the cell list for determining the common UL beam (i.e. common spatial relation) and the power control parameters.

When cell list(s) are configured, simultaneous DL TCI state updating for all serving cells in one cell list is supported for the UE with joint DL/UL beam indication capability. In particular, a common TCI activation/deactivation MAC CE is used to activate DL TCI states of all serving cells in a cell list, if the serving cell ID contained in the common TCI activation/deactivation MAC CE is configured as part of the cell list.

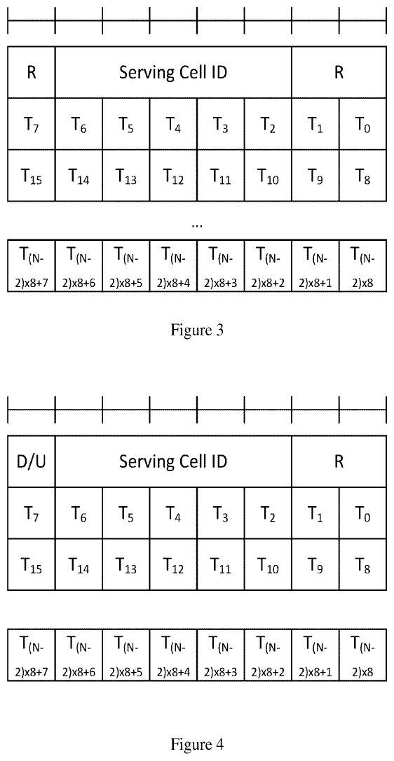

An example of the common TCI activation/deactivation MAC CE used to activate DL TCI states is illustrated in FIG. 3. Up to 128 DL TCI states can be configured for each serving cell. It has a variable size depending on the number of DL TCI states. When 128 DL TCI states are configured, N=17. The common TCI activation/deactivation MAC CE used to activate DL TCI states includes the following fields:

Serving Cell ID field: it indicates a serving cell for which the MAC CE applies.

Tᵢ field: each Tᵢ field indicates the activation or deactivation status of the DL TCI state with TCI-stateId i. The Tᵢ field is set to 1 to indicate that the DL TCI state with TCI-stateId i shall be activated and mapped to the codepoint indicated in the DCI TCI field. The Tᵢ field is set to 0 to indicate that the DL TCI state with TCI-stateId i shall be deactivated and is not mapped to the codepoint indicated in the DCI TCI field. The codepoint to which the DL TCI State is mapped is determined by its ordinal position among all the DL TCI States with Tᵢ field set to 1, i.e. the first DL TCI State with Tᵢ field set to 1 shall be mapped to the codepoint value 0, the second DL TCI State with Tᵢ field set to 1 shall be mapped to the codepoint value 1 and so on.

The maximum number of activated DL TCI states is 8. For example, when a UE receives a common TCI activation/deactivation MAC CE used to activate DL TCI states that activates DCI TCI states #2, #4, #6, #8, #10, #12, #14 and #16 (that is, T₂, T₄, T₆, T₈, T₁₀, T₁₂, T₁₄ and T₁₆ are set to 1, while other Tᵢ fields are set to 0) for serving cell 5, DL TCI states with IDs equal to 2, 4, 6, 8, 10, 12, 14 and 16 are activated for all serving cells 4, 5, 6 and 7 (serving cells 4, 5, 6 and 7 belong to one cell list, e.g. simultaneousCommonbeam-UpdatedList2-r17) and are mapped to TCI codepoints 0, 1, 2, 3, 4, 5, 6 and 7, respectively.

A DL TCI states pool can be configured for each serving cell by RRC signaling. Different DL TCI states pools may be configured for different serving cells (e.g. for serving cells 4, 5, 6 and 7). Therefore, the same TCI codepoint, which is mapped to the same TCI-stateId, may point to different DL TCI states (as they can be activated from different DL TCI states pools).

If the UE receives a DCI containing a TCI field with 010 (i.e. the TCI codepoint is 2) indicating a common UL beam change in serving cell 7, the common DL TCI state #6 (that is mapped to TCI codepoint 2) is applied to all of serving cells 4, 5, 6 and 7 (i.e. all serving cells in the cell list containing serving cell 7). It means that the UE shall apply DL TCI state #6 among all the DL TCI states configured on serving cells 4, 5, 6 and 7 for determining common UL beam for transmitting all UL channels in serving cells 4, 5, 6 and 7. Incidentally, for serving cells 4, 5, 6 and 7, DL TCI state #6 may point to different DL TCI states from different DL TCI states pools.

In the seventh embodiment, a further alternative SCS configuration for determining the actual duration of Y symbols is proposed: 3) the smallest of the SCS configurations of the active DL BWPs of all serving cells in the same cell list.

According to the seventh embodiment, when the UE receives a DCI (e.g. DCI format 1_1 or 1_2) with PDSCH assignment containing the TCI field indicating a DL TCI state for one serving cell in a cell list, the UE determines the common UL beam for UL transmission according to the indicated DL TCI state for each of all serving cells in the cell list, with the same manner as described in the third embodiment.

According to the seventh embodiment, the power control parameters are determined for each of all serving cells in the cell list with the same manner described in the fourth embodiment, i.e. according to the indicated DL TCI state.

A variety of the seventh embodiment describes simultaneous common UL beam indication for multiple cells, for the UE with separate DL/UL beam indication capability.

One or more cell lists, each of which contains multiple cells, can be configured for a UE with separate DL/UL beam indication capability for simultaneous common UL beam indication for all cells in a cell list. Note that the UE has separate DL/UL beam indication capability for all cells contained in the cell list. For example, a UE with separate DL/UL beam indication capability is configured with 8 serving cells. Serving cells with indices 0, 1, 2 and 3 can be configured to belong to one cell list, e.g., simultaneousCommonULTCI-UpdatedList1-r17, and serving cells with indices 4, 5, 6 and 7 can be configured to belong to another cell list, e.g., simultaneousCommonULTCI-UpdatedList2-r17.

According to the variety of the seventh embodiment, the network explicitly indicates that the UE supports common UL beam for all UL channels, with the same manner as described in the first embodiment. That is, the UE receives from the network (e.g. gNB) the higher layer parameter enable CommonBeamForUL set as ‘enabled’ to enable common UL beam for UL transmission for a carrier used by a serving cell with a serving cell ID. When the serving cell ID is configured as part of a cell list, simultaneous common UL beam updating for all serving cells in the cell list is supported.

According to the variety of the seventh embodiment, the common UL beam for all UL channels is determined by the spatialRelationInfo configured in the UL TCI state indicated in the TCI field contained in DCI (e.g. DCI format 1_1 or 1_2) without PDSCH assignment, with the same manner as described in the variety of the second embodiment. If a common UL beam is determined by the spatialRelationInfo configured in a UL TCI state indicated in the TCI field of a DCI format 1_1 or 1_2 without PDSCH assignment for a serving cell with a serving cell ID, when the serving cell ID is configured as part of a cell list, the indicated common UL beam applies to all serving cells in the cell list. That is, the UL TCI state with the same UL-TCI-stateId indicated in the TCI field of the DCI format 1_1 or 1_2 without PDSCH assignment applies to all serving cells in the cell list for determining the common UL beam (i.e. common spatial relation) and the power control parameters.

When cell list(s) are configured, simultaneous UL TCI state updating for all serving cells in one cell list is supported for the UE with separate DL/UL beam indication capability. In particular, a common UL TCI activation/deactivation MAC CE is used to activate UL TCI states of all serving cells in a cell list, if the serving cell ID contained in the common UL TCI activation/deactivation MAC CE is configured as part of the cell list.

An example of the common UL TCI activation/deactivation MAC CE is illustrated in FIG. 4. Up to 128 UL TCI states can be configured for each serving cell. The common UL TCI activation/deactivation MAC CE has a variable size depending on the number of UL TCI states. When 128 UL TCI states are configured, N=17. Note that although the MAC CE illustrated in FIG. 4 is named as common UL TCI activation/deactivation MAC CE, it can actually be used to update UL TCI states or DL TCI states. The common UL TCI activation/deactivation MAC CE illustrated in FIG. 4 includes the following fields:

Serving Cell ID field: it indicates a serving cell for which the MAC CE applies.

D/U field: D/U=1 indicates that this MAC CE applies for UL TCI state updating. This MAC CE can apply for DL TCI state updating when D/U=0 (it becomes the same as the common TCI activation/deactivation MAC CE shown in FIG. 3).

Tᵢ field: each Tᵢ field indicates the activation or deactivation status of the DL TCI state with TCI-stateId i for D/U=0 or the UL TCI state with UL-TCI-StateId i for D/U=1. The T i field is set to 1 to indicate that the DL TCI state with TCI-stateId i or the UL TCI state with UL-TCI-StateId i shall be activated and mapped to the codepoint indicated in the DCI TCI field. The Tᵢ field is set to 0 to indicate that the DL TCI state with TCI-stateId i or the UL TCI state with UL-TCI-StateId i shall be deactivated and is not mapped to the codepoint indicated in the DCI TCI field. The codepoint to which the UL (or DL) TCI State is mapped is determined by its ordinal position among all the UL (or DL) TCI States with Tᵢ field set to 1, i.e. the first UL (or DL) TCI State with Tᵢ field set to 1 shall be mapped to the codepoint value 0, the second UL (or DL) TCI State with Tᵢ field set to 1 shall be mapped to the codepoint value 1 and so on. The maximum number of activated UL (or DL) TCI states is 8.

For example, when a UE receives a common UL TCI activation/deactivation MAC CE that activates UL TCI states #2, #4, #6, #8, #10, #12, #14 and #16 (that is, D/U=1, and T₂, T₄, T₆, T₈, T₁₀, T₁₂, T₁₄ and T₁₆ are set to 1, while other Tᵢ fields are set to 0) for serving cell 5, UL TCI states with IDs equal to 2, 4, 6, 8, 10, 12, 14 and 16 are activated for all serving cells 4, 6 and 7 (serving cells 4, 5, 6 and 7 belong to one cell list, e.g. simultaneousCommonbeam-UpdatedList2-r17) and are mapped to TCI codepoints 0, 1, 2, 3, 4, 5, 6 and 7.

A UL TCI states pool can be configured for each serving cell by RRC signaling. Different UL TCI states pools may be configured for different serving cells (e.g. for serving cells 4, 5, 6 and 7). Therefore, the same TCI codepoint, which is mapped to the same UL-TCI-stateId, may point to different UL TCI states (as they can be activated from different UL TCI states pools).

If the UE receives a DCI containing a TCI field with 011 (i.e. the TCI codepoint is 3) indicating a common UL beam change in serving cell 7, the common UL TCI state #8 (that is mapped to TCI codepoint 3) is applied to all of serving cells 4, 5, 6 and 7 (i.e. all serving cells in a cell list containing serving cell 7). It means that the UE shall apply UL TCI state #8 among all the UL TCI states configured on serving cells 4, 5, 6 and 7 for determining common UL beam for transmitting all UL channels in serving cells 4, 5, 6 and 7. Incidentally, for serving cells 4, 5, 6 and 7, UL TCI state #8 may point to different UL TCI states from different UL TCI states pools.

According to the variety of the seventh embodiment, when the UE receives a DCI (e.g. DCI format 1_1 or 1_2) without PDSCH assignment containing the TCI field indicating a UL TCI state for one serving cell in a cell list, the UE determines the common UL beam for UL transmission according to the indicated UL TCI state for each of all serving cells in the cell list, with the same manner as described in the variety of the third embodiment.

According to the variety of the seventh embodiment, the power control parameters are determined for each of all serving cells in the cell list with the same manner described in the fourth embodiment, i.e. according to the indicated UL TCI state.

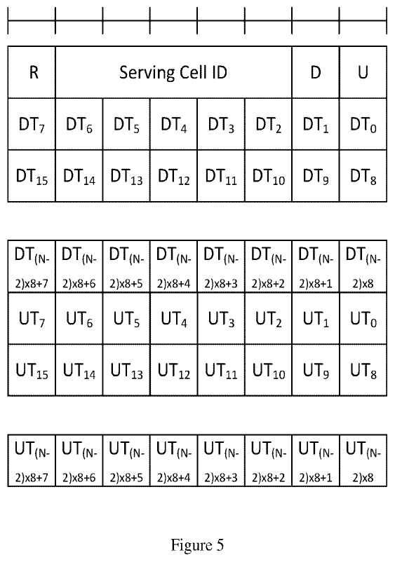

An example of common UL and DL TCI activation/deactivation MAC CE is provided in FIG. 5. Compared with the format provided in FIG. 4, the common UL and DL TCI activation/deactivation MAC CE illustrated in FIG. 5 can simultaneously update DL TCI states and UL TCI states for the UE with separate DL/UL beam indication capability. Up to 128 UL TCI states and up to 128 DL TCI states can be configured for each serving cell. The common UL and DL TCI activation/deactivation MAC CE has a variable size depending on the number of UL TCI states and the number of DL TCI states. When 128 UL TCI states and 128 DL TCI states are configured, N=17. The common UL and DL TCI activation/deactivation MAC CE illustrated in FIG. 5 includes the following fields:

Serving Cell ID field: it indicates a serving cell for which the MAC CE applies.

D field: it indicates the presence of the DTᵢ field (D=1). When D=0, none of DTᵢ fields are present.

U field: it indicates the presence of UTᵢ field (U=1). When U=0, none of UTᵢ fields are present.

DTᵢ field: each DTᵢ field indicates the activation or deactivation status of the DL TCI state with TCI-StateId i. Each of DTᵢ fields is present only when D=1.

UTᵢ field: each UTᵢ field indicates the activation or deactivation status of the UL TCI state with UL-TCI-StateId i. Each of UTᵢ fields is present only when U=1.

Each of the DTᵢ fields and each of the UTᵢ fields is set to 1 or 0 with the same principle as described with reference to the Tᵢ field in FIG. 3 or 4.

It can be seen that both DL TCI states and UL TCI states can be simultaneously updated by setting D=1 and U=1. Note that at least one of D field and U field should be set to 1.

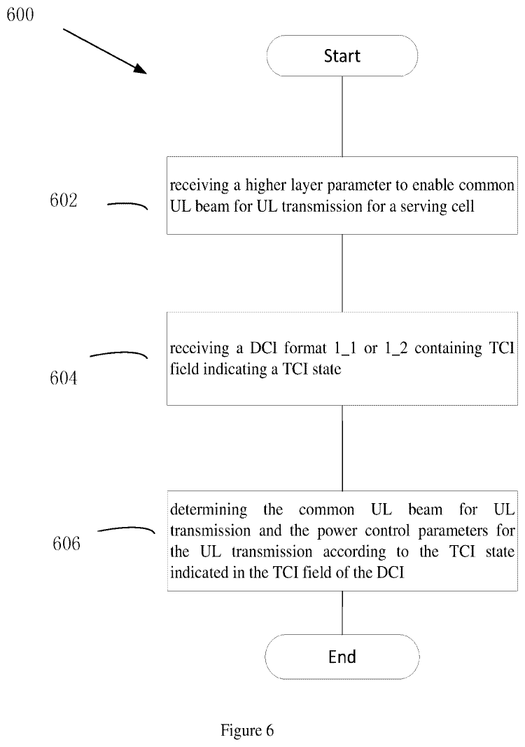

FIG. 6 is a schematic flow chart diagram illustrating an embodiment of a method 600 according to the present application. In some embodiments, the method 400 is performed by an apparatus, such as a remote unit. In certain embodiments, the method 400 may be performed by a processor executing program code, for example, a microcontroller, a microprocessor, a CPU, a GPU, an auxiliary processing unit, a FPGA, or the like.

The method 600 may include 602 receiving a higher layer parameter to enable common UL beam for UL transmission for a serving cell; 604 receiving a DCI format 1_1 or 1_2 containing TCI field indicating a TCI state; and 606 determining the common UL beam for UL transmission and the power control parameters for the UL transmission according to the TCI state indicated in the TCI field of the DCI.

For a UE with joint DL/UL beam indication capability, the common UL beam for UL transmission is determined by the QCL-TypeD RS configured in DL TCI state indicated in the TCI field in the DCI format 1_1 or 1_2 with PDSCH assignment. For a UE with separate DL/UL beam indication capability, the common UL beam for UL transmission is determined by the spatialRelationInfo configured in UL TCI state indicated in the TCI field in the DCI format 1_1 or 1_2 without PDSCH assignment.

Each TCI state is associated with a set of power control parameters for both PUCCH transmission and PUSCH transmission, or is associated with two sets of power control parameters including one set of power control parameters for PUCCH transmission and the other set of power control parameters for PUSCH transmission, wherein each set of power control parameters at least includes PL-RS. If no PL-RS is associated with the TCI state which is an indicated DL TCI state, a periodic DL RS with the same ID as the QCL-TypeD RS contained in the indicated DL TCI state is determined as the PL-RS. If no PL-RS is associated with the TCI state which is an indicated UL TCI state, a periodic DL RS with the same ID as the spatialRelationInfo configured in the indicated UL TCI state is determined as the PL-RS.

For the UE with joint DL/UL beam indication capability, the determined common UL beam for UL transmission and the determined PL-RS apply to all PUSCH transmissions and PUCCH transmissions for the serving cell, starting from the first slot that is Y symbols after the acknowledgment of the PDSCH transmission scheduled by the DCI, wherein Y is predetermined. The actual duration of Y symbols may be determined by 1) a SCS configuration of the active DL BWP for the PDCCH reception carrying the DCI, or 2) a SCS configuration of the active UL BWP for PUCCH or PUSCH transmission carrying the acknowledgement of the PDSCH transmission scheduled by the DCI. For the UE with separate DL/UL beam indication capability, the determined common UL beam for UL transmission and the determined PL-RS apply to all PUSCH transmissions and PUCCH transmissions for the serving cell, starting from the first slot that is Y symbols after the acknowledgment of the DCI, wherein Y is predetermined. The actual duration of Y symbols may be determined by 1) a SCS configuration of the active DL BWP for the PDCCH reception carrying the DCI, or 2′) a SCS configuration of the active UL BWP for PUCCH or PUSCH transmission carrying the acknowledgement of the DCI.

When the TCI field indicates a TCI codepoint pointing to two TCI states, the common UL beam for PUSCH transmission and PUCCH transmission without multi-TRP repetition and the power control parameters are determined according to a first TCI state of the two TCI states for a UE with joint DL/UL beam indication capability.

If a higher layer parameter CORESETPoolIndex is configured for each CORESET, the TCI state indicated in the TCI field of the DCI only applies to PUSCH transmission scheduled by a UL DCI transmitted from CORESET configured with the same CORESETPoolIndex value as that configured for the CORESET transmitting the DCI; CG-PUSCH associated with the same CORESETPoolIndex value as that configured for the CORESET transmitting the DCI; and PUCCH resources associated with the same CORESETPoolIndex value as that configured for the CORESET transmitting the DCI.

The method may further comprise receiving a configuration of one or more cell lists each of which is composed of one or multiple serving cells, wherein the common UL beam for UL transmission is enabled for all serving cells in a cell list containing the serving cell. If the TCI state is indicated in the TCI field of the DCI on the serving cell with a serving cell ID, when the serving cell ID is configured as part of a cell list, the TCI state with the same ID indicated in the TCI field applies to all serving cells in the cell list for determining the common UL beam for UL transmission and the power control parameters for the UL transmission, starting from the first slot that is Y symbols after the acknowledgment of the DCI or of the PDSCH transmission scheduled by the DCI, wherein Y is predetermined. The actual duration of Y symbols may be determined by the smallest of the SCS configurations of the active DL BWPs of all serving cells in the cell list.

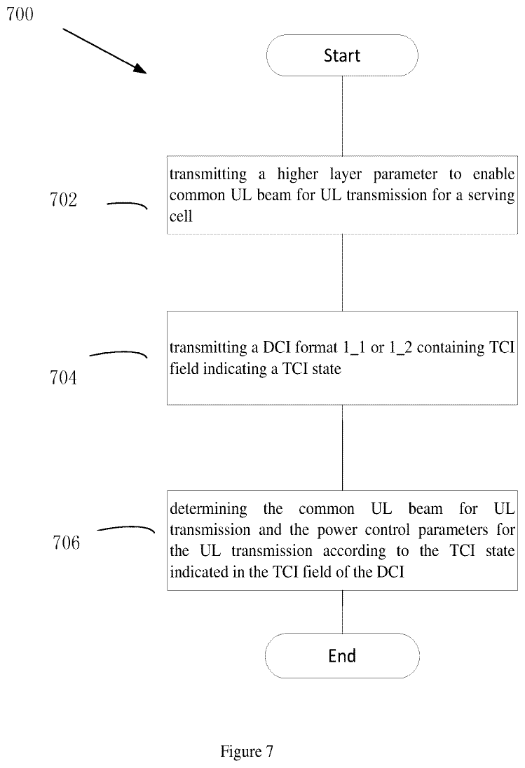

FIG. 7 is a schematic flow chart diagram illustrating an embodiment of a method 700 according to the present application. In some embodiments, the method 700 is performed by an apparatus, such as a base unit. In certain embodiments, the method 700 may be performed by a processor executing program code, for example, a microcontroller, a microprocessor, a CPU, a GPU, an auxiliary processing unit, a FPGA, or the like. The method 700 may include 702 transmitting a higher layer parameter to enable

common UL beam for UL transmission for a serving cell; 704 transmitting a DCI format 1_1 or 1_2 containing TCI field indicating a TCI state; and 706 determining the common UL beam for UL transmission and the power control parameters for the UL transmission according to the TCI state indicated in the TCI field of the DCI.

For the UE with joint DL/UL beam indication capability, the common UL beam for UL transmission is determined by the QCL-TypeD RS configured in DL TCI state indicated in the TCI field in the DCI format 1_1 or 1_2 with PDSCH assignment. For the UE with separate DL/UL beam indication capability, the common UL beam for UL transmission is determined by the spatialRelationInfo configured in UL TCI state indicated in the TCI field in the DCI format 1_1 or 1_2 without PDSCH assignment.

Each TCI state is associated with a set of power control parameters for both PUCCH transmission and PUSCH transmission, or is associated with two sets of power control parameters including one set of power control parameters for PUCCH transmission and the other set of power control parameters for PUSCH transmission, wherein each set of power control parameters at least includes PL-RS. If no PL-RS is associated with the TCI state which is an indicated DL TCI state, a periodic DL RS with the same ID as the QCL-TypeD RS contained in the indicated DL TCI state is determined as the PL-RS. If no PL-RS is associated with the TCI state which is an indicated UL TCI state, a periodic DL RS with the same ID as the spatialRelationInfo configured in the indicated UL TCI state is determined as the PL-RS.

For the UE with joint DL/UL beam indication capability, the determined common UL beam for UL transmission and the determined PL-RS apply to all PUSCH transmissions and PUCCH transmissions for the serving cell, starting from the first slot that is Y symbols after the acknowledgment of the PDSCH transmission scheduled by the DCI, wherein Y is predetermined. The actual duration of Y symbols may be determined by 1) a SCS configuration of the active DL BWP for the PDCCH reception carrying the DCI, or 2) a SCS configuration of the active UL BWP for PUCCH or PUSCH transmission carrying the acknowledgement of the PDSCH transmission scheduled by the DCI. For the UE with separate DL/UL beam indication capability, the determined common UL beam for UL transmission and the determined PL-RS apply to all PUSCH transmissions and PUCCH transmissions for the serving cell, starting from the first slot that is Y symbols after the acknowledgment of the DCI, wherein Y is predetermined. The actual duration of Y symbols may be determined by 1) a SCS configuration of the active DL BWP for the PDCCH reception carrying the DCI, or 2′) a SCS configuration of the active UL BWP for PUCCH or PUSCH transmission carrying the acknowledgement of the DCI.

When the TCI field indicates a TCI codepoint pointing to two TCI states, the common UL beam for PUSCH transmission and PUCCH transmission without multi-TRP repetition and the power control parameters are determined according to a first TCI state of the two TCI states for a UE with joint DL/UL beam indication capability.

If a higher layer parameter CORESETPoolIndex is configured for each CORESET, the TCI state indicated in the TCI field of the DCI only applies to PUSCH transmission scheduled by a UL DCI transmitted from CORESET configured with the same CORESETPoolIndex value as that configured for the CORESET transmitting the DCI; CG-PUSCH associated with the same CORESETPoolIndex value as that configured for the CORESET transmitting the DCI; and PUCCH resources associated with the same CORESETPoolIndex value as that configured for the CORESET transmitting the DCI.

The method may further comprise transmitting a configuration of one or more cell lists each of which is composed of one or multiple serving cells, wherein the common UL beam for UL transmission is enabled for all serving cells in a cell list containing the serving cell. If the TCI state is indicated in the TCI field of the DCI on the serving cell with a serving cell ID, when the serving cell ID is configured as part of a cell list, the TCI state with the same ID indicated in the TCI field applies to all serving cells in the cell list for determining the common UL beam for UL transmission and the power control parameters for the UL transmission, starting from the first slot that is Y symbols after the acknowledgment of the DCI or of the PDSCH transmission scheduled by the DCI, wherein Y is predetermined. The actual duration of Y symbols may be determined by the smallest of the SCS configurations of the active DL BWPs of all serving cells in the cell list.

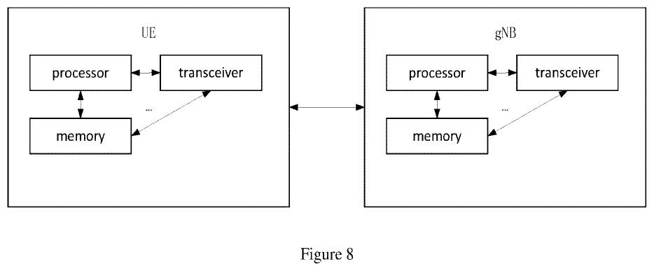

FIG. 8 is a schematic block diagram illustrating apparatuses according to one embodiment.

Referring to FIG. 8, the UE (i.e. the remote unit) includes a processor, a memory, and a transceiver. The processor implements a function, a process, and/or a method which are proposed in FIG. 6.

The remote unit comprises a receiver that receives a higher layer parameter to enable common UL beam for UL transmission for a serving cell, and receives a DCI format 1_1 or 1_2 containing TCI field indicating a TCI state; and a processor that determines the common UL beam for UL transmission and the power control parameters for the UL transmission according to the TCI state indicated in the TCI field of the DCI.

For the UE with joint DL/UL beam indication capability, the common UL beam for UL transmission is determined by the QCL-TypeD RS configured in DL TCI state indicated in the TCI field in the DCI format 1_1 or 1_2 with PDSCH assignment. For the UE with separate DL/UL beam indication capability, the common UL beam for UL transmission is determined by the spatialRelationInfo configured in UL TCI state indicated in the TCI field in the DCI format 1_1 or 1_2 without PDSCH assignment.

Each TCI state is associated with a set of power control parameters for both PUCCH transmission and PUSCH transmission, or is associated with two sets of power control parameters including one set of power control parameters for PUCCH transmission and the other set of power control parameters for PUSCH transmission, wherein each set of power control parameters at least includes PL-RS. If no PL-RS is associated with the TCI state which is an indicated DL TCI state, a periodic DL RS with the same ID as the QCL-TypeD RS contained in the indicated DL TCI state is determined as the PL-RS. If no PL-RS is associated with the TCI state which is an indicated UL TCI state, a periodic DL RS with the same ID as the spatialRelationInfo configured in the indicated UL TCI state is determined as the PL-RS.

For the UE with joint DL/UL beam indication capability, the determined common UL beam for UL transmission and the determined PL-RS apply to all PUSCH transmissions and PUCCH transmissions for the serving cell, starting from the first slot that is Y symbols after the acknowledgment of the PDSCH transmission scheduled by the DCI, wherein Y is predetermined. The actual duration of Y symbols may be determined by 1) a SCS configuration of the active DL BWP for the PDCCH reception carrying the DCI, or 2) a SCS configuration of the active UL BWP for PUCCH or PUSCH transmission carrying the acknowledgement of the PDSCH transmission scheduled by the DCI. For the UE with separate DL/UL beam indication capability, the determined common UL beam for UL transmission and the determined PL-RS apply to all PUSCH transmissions and PUCCH transmissions for the serving cell, starting from the first slot that is Y symbols after the acknowledgment of the DCI, wherein Y is predetermined. The actual duration of Y symbols may be determined by 1) a SCS configuration of the active DL BWP for the PDCCH reception carrying the DCI, or 2′) a SCS configuration of the active UL BWP for PUCCH or PUSCH transmission carrying the acknowledgement of the DCI.

When the TCI field indicates a TCI codepoint pointing to two TCI states, the common UL beam for PUSCH transmission and PUCCH transmission without multi-TRP repetition and the power control parameters are determined according to a first TCI state of the two TCI states for a UE with joint DL/UL beam indication capability.

If a higher layer parameter CORESETPoolIndex is configured for each CORESET, the TCI state indicated in the TCI field of the DCI only applies to PUSCH transmission scheduled by a UL DCI transmitted from CORESET configured with the same CORESETPoolIndex value as that configured for the CORESET transmitting the DCI; CG-PUSCH associated with the same CORESETPoolIndex value as that configured for the CORESET transmitting the DCI; and PUCCH resources associated with the same CORESETPoolIndex value as that configured for the CORESET transmitting the DCI.

The receiver may further receive a configuration of one or more cell lists each of which is composed of one or multiple serving cells, wherein the common UL beam for UL transmission is enabled for all serving cells in a cell list containing the serving cell. If the TCI state is indicated in the TCI field of the DCI on the serving cell with a serving cell ID, when the serving cell ID is configured as part of a cell list, the TCI state with the same ID indicated in the TCI field applies to all serving cells in the cell list for determining the common UL beam for UL transmission and the power control parameters for the UL transmission, starting from the first slot that is Y symbols after the acknowledgment of the DCI or of the PDSCH transmission scheduled by the DCI, wherein Y is predetermined. The actual duration of Y symbols may be determined by the smallest of the SCS configurations of the active DL BWPs of all serving cells in the cell list.

The gNB (i.e. base unit) includes a processor, a memory, and a transceiver. The processors implement a function, a process, and/or a method which are proposed in FIG. 7.

The base unit comprises a transmitter that transmits a higher layer parameter to enable common UL beam for UL transmission for a serving cell, and receives a DCI format 1_1 or 1_2 containing TCI field indicating a TCI state; and a processor that determines the common UL beam for UL transmission and the power control parameters for the UL transmission according to the TCI state indicated in the TCI field of the DCI.

For the UE with joint DL/UL beam indication capability, the common UL beam for UL transmission is determined by the QCL-TypeD RS configured in DL TCI state indicated in the TCI field in the DCI format 1_1 or 1_2 with PDSCH assignment. For the UE with separate DL/UL beam indication capability, the common UL beam for UL transmission is determined by the spatialRelationInfo configured in UL TCI state indicated in the TCI field in the DCI format 1_1 or 1_2 without PDSCH assignment.

Each TCI state is associated with a set of power control parameters for both PUCCH transmission and PUSCH transmission, or is associated with two sets of power control parameters including one set of power control parameters for PUCCH transmission and the other set of power control parameters for PUSCH transmission, wherein each set of power control parameters at least includes PL-RS. If no PL-RS is associated with the TCI state which is an indicated DL TCI state, a periodic DL RS with the same ID as the QCL-TypeD RS contained in the indicated DL TCI state is determined as the PL-RS. If no PL-RS is associated with the TCI state which is an indicated UL TCI state, a periodic DL RS with the same ID as the spatialRelationInfo configured in the indicated UL TCI state is determined as the PL-RS.

For the UE with joint DL/UL beam indication capability, the determined common UL beam for UL transmission and the determined PL-RS apply to all PUSCH transmissions and PUCCH transmissions for the serving cell, starting from the first slot that is Y symbols after the acknowledgment of the PDSCH transmission scheduled by the DCI, wherein Y is predetermined. The actual duration of Y symbols may be determined by 1) a SCS configuration of the active DL BWP for the PDCCH reception carrying the DCI, or 2) a SCS configuration of the active UL BWP for PUCCH or PUSCH transmission carrying the acknowledgement of the PDSCH transmission scheduled by the DCI. For the UE with separate DL/UL beam indication capability, the determined common UL beam for UL transmission and the determined PL-RS apply to all PUSCH transmissions and PUCCH transmissions for the serving cell, starting from the first slot that is Y symbols after the acknowledgment of the DCI, wherein Y is predetermined. The actual duration of Y symbols may be determined by 1) a SCS configuration of the active DL BWP for the PDCCH reception carrying the DCI, or 2′) a SCS configuration of the active UL BWP for PUCCH or PUSCH transmission carrying the acknowledgement of the DCI.

When the TCI field indicates a TCI codepoint pointing to two TCI states, the common UL beam for PUSCH transmission and PUCCH transmission without multi-TRP repetition and the power control parameters are determined according to a first TCI state of the two TCI states for a UE with joint DL/UL beam indication capability.

If a higher layer parameter CORESETPoolIndex is configured for each CORESET, the TCI state indicated in the TCI field of the DCI only applies to PUSCH transmission scheduled by a UL DCI transmitted from CORESET configured with the same CORESETPoolIndex value as that configured for the CORESET transmitting the DCI; CG-PUSCH associated with the same CORESETPoolIndex value as that configured for the CORESET transmitting the DCI; and PUCCH resources associated with the same CORESETPoolIndex value as that configured for the CORESET transmitting the DCI.

The transmitter may further transmit a configuration of one or more cell lists each of which is composed of one or multiple serving cells, wherein the common UL beam for UL transmission is enabled for all serving cells in a cell list containing the serving cell. If the TCI state is indicated in the TCI field of the DCI on the serving cell with a serving cell ID, when the serving cell ID is configured as part of a cell list, the TCI state with the same ID indicated in the TCI field applies to all serving cells in the cell list for determining the common UL beam for UL transmission and the power control parameters for the UL transmission, starting from the first slot that is Y symbols after the acknowledgment of the DCI or of the PDSCH transmission scheduled by the DCI, wherein Y is predetermined. The actual duration of Y symbols may be determined by the smallest of the SCS configurations of the active DL BWPs of all serving cells in the cell list.

Layers of a radio interface protocol may be implemented by the processors. The memories are connected with the processors to store various pieces of information for driving the processors. The transceivers are connected with the processors to transmit and/or receive a radio signal. Needless to say, the transceiver may be implemented as a transmitter to transmit the radio signal and a receiver to receive the radio signal.

The memories may be positioned inside or outside the processors and connected with the processors by various well-known means.

In the embodiments described above, the components and the features of the embodiments are combined in a predetermined form. Each component or feature should be considered as an option unless otherwise expressly stated. Each component or feature may be implemented not to be associated with other components or features. Further, the embodiment may be configured by associating some components and/or features. The order of the operations described in the embodiments may be changed. Some components or features of any embodiment may be included in another embodiment or replaced with the component and the feature corresponding to another embodiment. It is apparent that the claims that are not expressly cited in the claims are combined to form an embodiment or be included in a new claim.

The embodiments may be implemented by hardware, firmware, software, or combinations thereof. In the case of implementation by hardware, according to hardware implementation, the exemplary embodiment described herein may be implemented by using one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and the like.

Embodiments may be practiced in other specific forms. The described embodiments are to be considered in all respects to be only illustrative and not restrictive. The scope of the invention is, therefore, indicated in the appended claims rather than by the foregoing description. All changes which come within the meaning and range of equivalency of the claims are to be embraced within their scope.

1. A method, comprising:
receiving a higher layer parameter to enable a common uplink (UL) beam for UL transmission for a serving cell;
receiving a downlink control information (DCI) format 1_1 or DCI format 1_2 containing a transmission configuration indication (TCI) field indicating a TCI state; and
determining the common UL beam for the UL transmission and power control parameters for the UL transmission according to the TCI state indicated in the TCI field of the DCI.

2. The method of claim 1, wherein, the common UL beam for the UL transmission is determined by a quasi co-location (QCL)-TypeD reference signal (RS) configured in the TCI state indicated in the TCI field in the DCI format 1_1 or the DCI format 1_2 with a physical downlink shared channel (PDSCH) assignment for a user equipment (UE) with joint DL/UL beam indication capability.

3. The method of claim 1, wherein, the common UL beam for the UL transmission is determined by spatialRelationInfo configured in an UL TCI state indicated in the TCI field in the DCI format 1_1 or the DCI format 1_2 without a physical downlink shared channel (PDSCH) assignment for a user equipment (UE) with separate downlink (DL)/UL beam indication capability.

4. The method of claim 1, wherein, the TCI state is associated with a set of power control parameters for both physical uplink control channel (PUCCH) transmission and physical uplink shared channel (PUSCH) transmission, or is associated with two sets of power control parameters including one set of the power control parameters for the PUCCH transmission and another set of the power control parameters for the PUSCH transmission, wherein each set of the power control parameters at least includes a pathloss reference signal (PL-RS).

5-8. (canceled)

9. The method of claim 1, wherein, if a higher layer parameter CORESETPoolIndex is configured for each control resource set CORESET), the TCI state indicated in the TCI field of the DCI only applies to:
a physical uplink shared channel (PUSCH) transmission scheduled by a UL DCI transmitted from the CORESET configured with a same CORESETPoolIndex value as that configured for the CORESET transmitting the DCI;
a configured grant (CG)-PUSCH associated with the same CORESETPoolIndex value as that configured for the CORESET transmitting the DCI; and
physical uplink control channel (PUCCH) resources associated with the same CORESETPoolIndex value as that configured for the CORESET transmitting the DCI.

10. The method of claim 1, further comprising:
receiving a configuration of one or more cell lists each of which is composed of one or multiple serving cells, wherein the common UL beam for the UL transmission is enabled for all serving cells in a cell list containing the serving cell.

11. The method of claim 10, wherein, if the TCI state is indicated in the TCI field of the DCI on the serving cell with a serving cell identifier (ID) that is configured as part of the cell list, the TCI state with a same ID indicated in the TCI field applies to all of the serving cells in the cell list for the determining the common UL beam for the UL transmission and the power control parameters for the UL transmission, starting from a first slot that is a predetermined number of symbols after acknowledgment of the DCI or of a physical downlink shared channel (PDSCH) transmission scheduled by the DCI.

12. The method of claim 11, wherein, a duration of the predetermined number of symbols is determined by a smallest of subcarrier space (SCS) configurations of active downlink (DL) bandwidth parts (BWPs) of all of the serving cells in the cell list.

13. An apparatus, comprising:
a processor; and
a memory coupled with the processor, the processor configured to cause the apparatus to:
transmit a higher layer parameter to enable a common uplink (UL) beam for UL transmission for a serving cell;
transmit a downlink control information (DCI) format 1_1 or DCI format 1_2 containing a transmission configuration indication (TCI) field indicating a TCI state; and
determine the common UL beam for the UL transmission and power control parameters for the UL transmission according to the TCI state indicated in the TCI field of the DCI.

14. An apparatus, comprising:
a processor; and
a memory coupled with the processor, the processor configured to cause the apparatus to:
receive a higher layer parameter to enable a common uplink (UL) beam for UL transmission for a serving cell;
receive a downlink control information (DCI) format 1_1 or DCI format 1_2 containing a transmission configuration indication (TCI) field indicating a TCI state; and
determine the common UL beam for the UL transmission and power control parameters for the UL transmission according to the TCI state indicated in the TCI field of the DCI.

15. (canceled)

16. The apparatus of claim 14, wherein the common UL beam for the UL transmission is determined by a quasi co-location (QCL)-TypeD reference signal (RS) configured in the TCI state indicated in the TCI field in the DCI format 1_1 or the DCI format 1_2 with a physical downlink shared channel (PDSCH) assignment for a user equipment (UE) with joint DL/UL beam indication capability.

17. The apparatus of claim 16, wherein if no pathloss reference signal (PL-RS) is associated with the indicated DL TCI state, a periodic DL RS with a same identifier (ID) as the QCL-TypeD RS contained in the indicated DL TCI state is determined as the PL-RS.

18. The apparatus of claim 14, wherein the common UL beam for the UL transmission is determined by spatialRelationInfo configured in an UL TCI state indicated in the TCI field in the DCI format 1_1 or the DCI format 1_2 without a physical downlink shared channel (PDSCH) assignment for a user equipment (UE) with separate downlink (DL)/UL beam indication capability.

19. The apparatus of claim 18, wherein if no pathloss reference signal (PL-RS) is associated with the indicated UL TCI state, a periodic DL RS with a same identifier (ID) as the spatialRelationInfo configured in the indicated UL TCI state is determined as the PL-RS.

20. The apparatus of claim 14, wherein the TCI state is associated with a set of power control parameters for both physical uplink control channel (PUCCH) transmission and physical uplink shared channel (PUSCH) transmission, or is associated with two sets of power control parameters including one set of the power control parameters for the PUCCH transmission and another set of the power control parameters for the PUSCH transmission, wherein each set of the power control parameters at least includes a pathloss reference signal (PL-RS).

21. The apparatus of claim 20, wherein the determined common UL beam for the UL transmission and a determined pathloss reference signal (PL-RS) apply to all PUSCH transmissions and PUCCH transmissions for the serving cell, starting from a first slot that is a predetermined number of symbols after acknowledgment of the DCI.

22. The apparatus of claim 21, wherein a duration of the predetermined number of symbols is determined by one of a subcarrier space (SCS) configuration of an active downlink (DL) bandwidth part (BWP) for a physical downlink control channel (PDCCH) reception carrying the DCI, or a SCS configuration of an active UL BWP for PUCCH transmission or PUSCH transmission carrying the acknowledgement of the DCI.

23. The apparatus of claim 14, wherein, if a higher layer parameter CORESETPoolIndex is configured for each control resource set (CORESET), the TCI state indicated in the TCI field of the DCI only applies to:
a physical uplink shared channel (PUSCH) transmission scheduled by a UL DCI transmitted from the CORESET configured with a same CORESETPoolIndex value as that configured for the CORESET transmitting the DCI;
a configured grant (CG)-PUSCH associated with the same CORESETPoolIndex value as that configured for the CORESET transmitting the DCI; and
physical uplink control channel (PUCCH) resources associated with the same CORESETPoolIndex value as that configured for the CORESET transmitting the DCI.

24. The apparatus of claim 14, wherein the processor is configured to cause the apparatus to receive a configuration of one or more cell lists each of which is composed of one or multiple serving cells, wherein the common UL beam for the UL transmission is enabled for all serving cells in a cell list containing the serving cell.

25. The apparatus of claim 14, wherein if the TCI state is indicated in the TCI field of the DCI on the serving cell with a serving cell identifier (ID) that is configured as part of a cell list, the TCI state with a same ID indicated in the TCI field applies to all of the serving cells in the cell list for the determining the common UL beam for the UL transmission and the power control parameters for the UL transmission, starting from a first slot that is a predetermined number of symbols after acknowledgment of the DCI or of a physical downlink shared channel (PDSCH) transmission scheduled by the DCI.
